(19) United States
(12) Patent Application Publication
(10) Pub. No.: US 2017/0030296 A1
(43) Pub. Date: Feb. 2, 2017

(54) THRUST REVERSER PROVIDING INCREASED BLOCKER DOOR LEAKAGE

(71) Applicant: Rohr, Inc., Chula Vista, CA (US)

(72) Inventors: Landy Dong, La Jolla, CA (US); Yu Awata, La Mesa, CA (US)

(21) Appl. No.: 14/811,762

(22) Filed: Jul. 28, 2015

(51) Int. Cl. F02K 1/68

(52) U.S. Cl. CPC F02K 1/68

(57) ABSTRACT

A thrust reverser included in an aircraft nacelle includes an annular nacelle, a blocker door assembly, and a cascade assembly. The annular nacelle has an inner hollowed area defining a fan duct that extends longitudinally along an axis between an upstream inlet and a downstream outlet. The blocker door assembly is disposed in the fan duct and between the upstream inlet and the downstream outlet. The blocker door assembly is configured to selectively deploy a plurality of blocker doors that extend radially from the nacelle into the fan duct so as to form a plurality of air leakage paths that define a total leakage area (A_{L}). The cascade assembly is circumferentially disposed upstream from the blocker door assembly. The cascade assembly including a plurality of vents that define an inner circumferential area (A_{C2}) of the cascade assembly as a ratio (R_{C}) with respect to the A_{L}.

### TECHNICAL FIELD

The disclosure generally relates to aircraft propulsion system, and more particular, to aircraft engine thrust reversers.

### BACKGROUND

Recent trends in aviation engineering have led to the pursuit of higher bypass ratio nacelle designs in order to improve the engine thrust specific fuel consumption (TSFC) and thereby overall system efficiency. Very High Bypass Ratio (VHBR) engines are being pursued to increase propulsive efficiencies. In large engines, VHBR results in large fans and associated fan ducts, and thus must be designed with a larger exhaust area to accommodate the increased fan airflow. However, these VHBR engines require the nacelle surfaces to be minimized to obtain acceptable airframe integration losses.

Typical VHBR engines have a nacelle with reduced fineness ratio due to the requirement for minimization of the wetted surface areas. The exhaust area available through the cascade array and leakage paths during thrust reverser operation must be able to meet the increased fan exit area necessary to maintain adequate engine operating margins. These requirements result in a nacelle having a reduced volume within the nacelle interior to accommodate the packaging of cascade thrust reverser. The cascade arrays included in the nacelle are shorter than the length typically required to satisfy both the fan exhaust area and the reverse thrust specifications. This additional area can be provided by allowing for increased leakage around the periphery of the blocker doors.

### SUMMARY

According to a non-limiting embodiment, a thrust reverser included in an aircraft nacelle includes an annular nacelle, a blocker door assembly, and a cascade assembly. The annular nacelle has an inner hollowed area defining a fan duct that extends longitudinally along an axis between an upstream inlet and a downstream outlet. The blocker door assembly is disposed in the fan duct and between the upstream inlet and the downstream outlet. The blocker door assembly is configured to selectively deploy a plurality of blocker doors that extend radially from the nacelle into the fan duct so as to form a plurality of air leakage paths that define a total leakage area (A_{L}). The cascade assembly is circumferentially disposed upstream from the blocker door assembly. The cascade assembly including a plurality of vents that define an inner circumferential area (A_{C2}) of the cascade assembly as a ratio (R_{C}) with respect to the A_{L}.

According to another non-limiting embodiment, a method of controlling a thrust reverser installed in a fan duct of an aircraft nacelle includes deploying a plurality of blocker doors interposed between an upstream portion of the fan duct and a downstream portion of the fan duct. The blocker doors define a plurality of air leakage passages between the upstream portion and the downstream portion. The method further includes directing a first portion of an airflow stream flowing in the upstream portion through a cascade assembly disposed in the upstream portion of the fan duct. The method further includes directing a second portion of the airflow stream through the air leakage passages defined by the blocker doors and into the downstream portion, wherein approximately 80 percent of the airflow stream is passed through the cascade assembly while approximately 20 percent of the airflow stream is passed through the air leakage passages.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of the nacelle system including a cascade thrust reverser assembly according to a non-limiting embodiment;

FIG. 2 is close-up view of the thrust reverser in a fully-deployed position according to a non-limiting embodiment;

FIGS. 3A-3B are a cross-sectional views of the aircraft thrust reverser illustrated in FIG. 3 taken along line A-A′ looking aft to show the circumferential arrangement of the deployed blocker doors to inhibit airflow through the fan duct;

FIG. 4 illustrates a cascade array assembly excluding the blocker door assembly according to a non-limiting embodiment; and

FIG. 5 is perspective view of the aircraft thrust reverser with the blocker doors fully deployed and showing a majority of the airflow traveling through the fan duct exiting through the cascades, while a portion of the airflow is allowed to bypass the blocker door assembly via leakage paths defined by the arrangement of the individual blocker doors according to a non-limiting embodiment.

### DETAILED DESCRIPTION

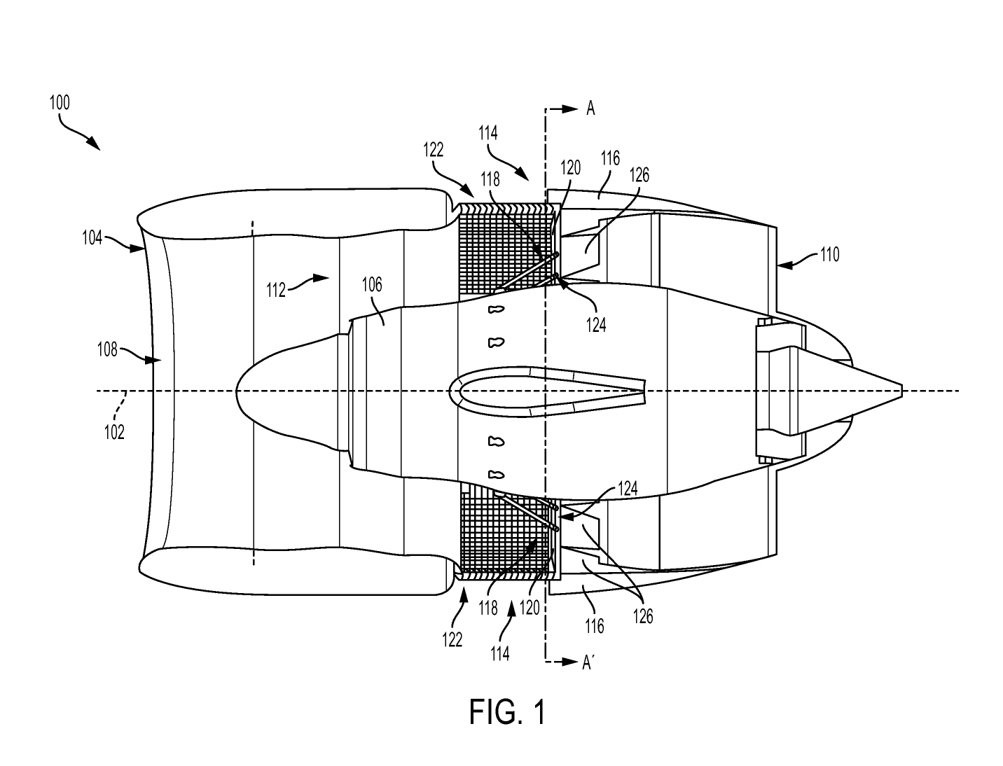

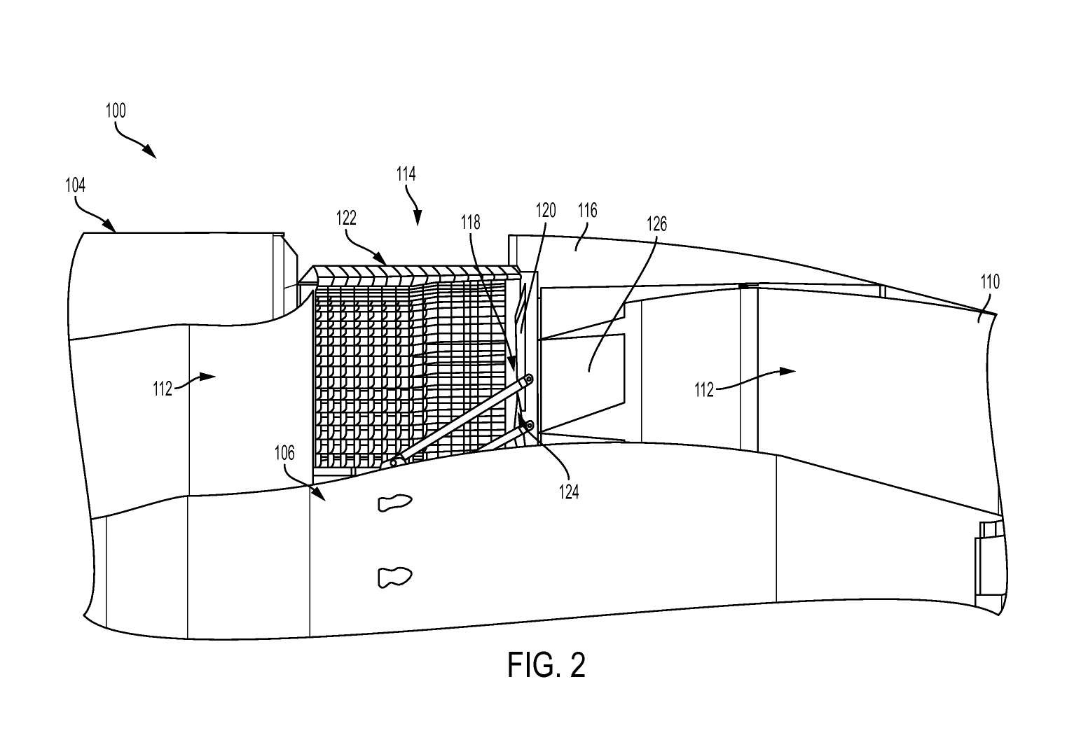

With reference now to FIGS. 1 and 2, a gas turbine propulsion system 100 is illustrated extending along and is arranged around a longitudinal axis or rotational axis 102. The gas turbine propulsion system 100 includes an annular nacelle 104 that surrounds an inner fixed structure (IFS) 106. The annular nacelle 104 includes an upstream portion defining an inlet 108 and a downstream portion defining a fan nozzle exit 110. A space between the inner surface of the annular nacelle 104 and the IFS 106 defines an annular flow path or the fan duct 112. The fan duct 112 extends along the longitudinal axis 102 from the inlet 108 to the fan nozzle exit 110. In this manner, airflow entering the inlet 108 may travel along the fan duct 112 and be exhausted at fan nozzle exit 110 to produce forward thrust.

The annular nacelle system 104 further includes a thrust reverser 114 interposed between the upstream portion 108 and the downstream portion 110. The thrust reverser 114 includes a translating sleeve 116, a blocker door assembly 118 having a plurality of blocker doors 120, and a cascade assembly 122. The translating sleeve 116 slides forward and backward in the direction of the longitudinal axis 102 so as to mechanically operate the thrust reverser 114 as discussed in greater detail below.

The blocker doors 120 are positionable between a fully deployed state and a fully stowed state. When initiating the blocker doors 120 into the fully deployed state (see FIG. 2) the translating sleeve 116 moves with respect to the fixed case of the annular nacelle 104 and slides backward toward the fan nozzle exit 110. As the translating sleeve 116 slides backward, the blocker door assembly 118 is operated such that the blocker doors 120 are disposed so as to extend radially inwardly from the translating sleeve 116 and are positioned generally normal to the longitudinal axis 102. In addition, the cascade assemblies 122 are uncovered such that the vents provide a path for airflow to exit the fan duct 112 as understood by one of ordinary skill in the art. While the blocker doors are fully deployed, a majority of airflow (AF) entering the inlet 108 is diverted radially with respect to the longitudinal axis 102 and is exhausted from the fan duct 112 via the exposed cascade assembly 122. A portion of the airflow, however, is allowed to flow through one or more air leakage paths 124 defined by the blocker doors 120 and the fan duct cross-section. In this manner, a reverse thrust is produced and controlled in a manner so as to decelerate the aircraft.

When initiating the blocker doors 120 into the fully stowed state (not shown), the translating sleeve 116 with respect to the fixed case of the annular nacelle 104 and slides forward toward the upstream portion 108. As the translating sleeve 116 slides forward, the blocker door assembly 118 is operated such that the blocker doors 120 are retracted into respective recesses 126 formed in the inner surface of the translating sleeve 116. In addition, the cascade assemblies 122 are covered so as to prevent airflow from exhausting therethrough. In this manner, essentially the full airflow entering the inlet 108 is directed past the blocker door assembly 118 and through the fan duct 112 where it is exhausted from the fan nozzle exit 110 to promote forward thrust of the aircraft.

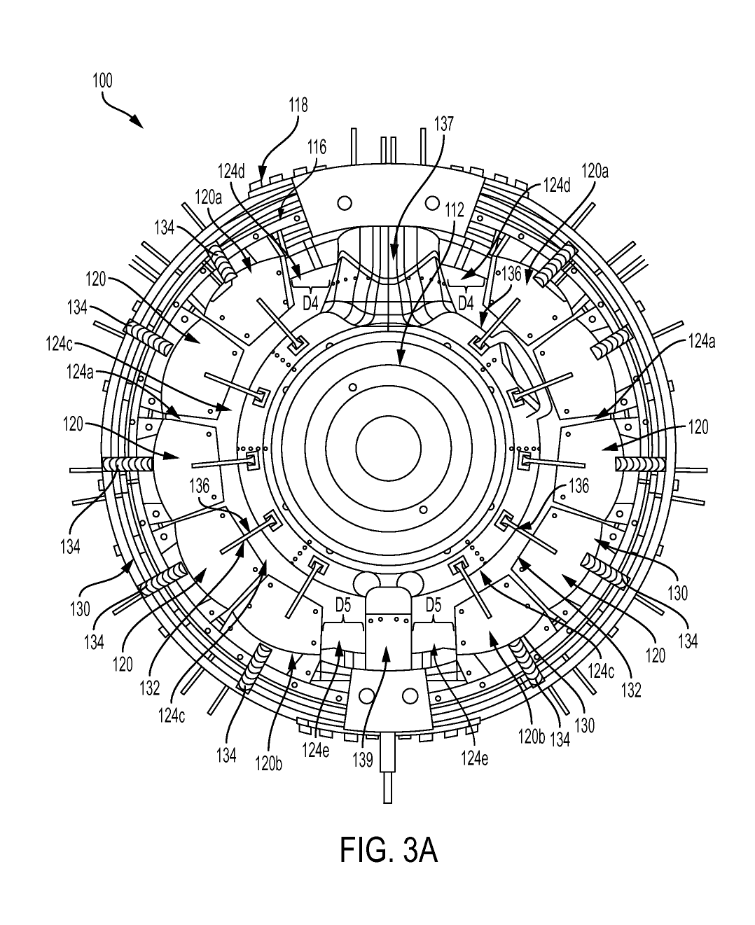

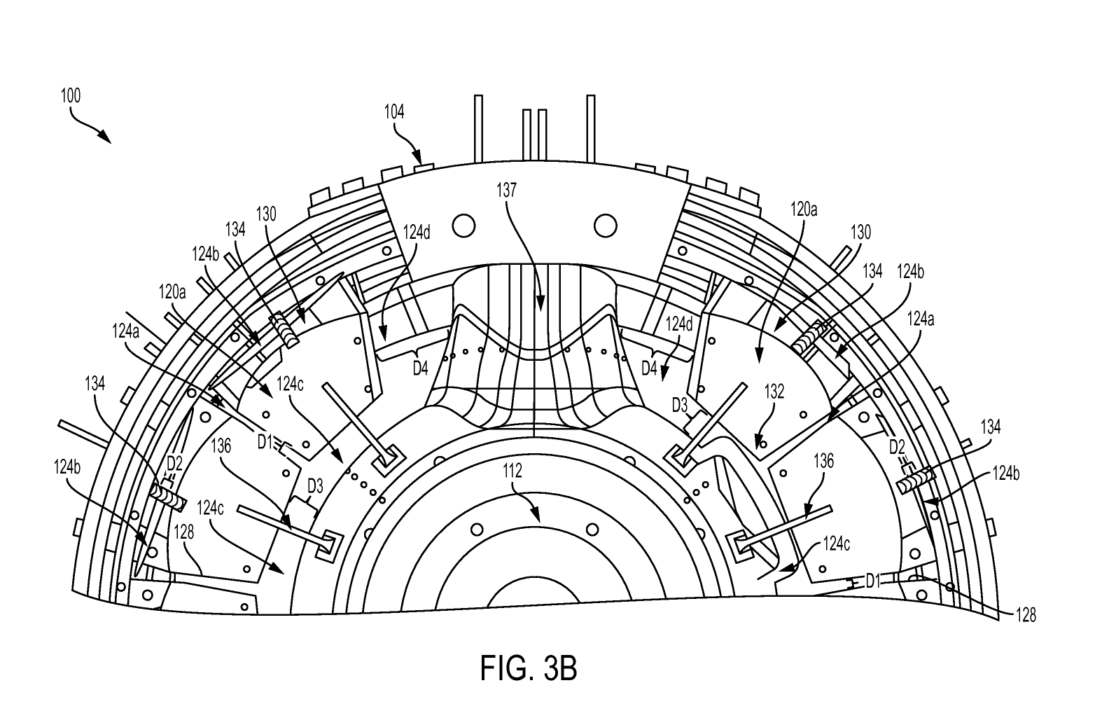

Turning to FIGS. 3A-3B, cross-sectional images of the engine 112 taken along line A-A′ illustrate the thrust reverser 114 viewed from the upstream portion 108 according to a non-limiting embodiment. When fully deployed, the blocker doors 120 define a plurality of leakage paths 124 that allow air flow to leak past the blocker door assembly 118. For instance, the blocker doors 120 have tapered side edges 128 (see FIG. 3B) that extend between a proximate edge 130 and a distal edge 132. Each neighboring tapered side edge 128 is spaced apart from one another by a distance (D1) to define a side edge leakage path 124a. The spacing of D1 may range from approximately 2.5 mm (0.1 inches) to approximately 6 mm (0.25 inches), but is typically established to from the minimum clearance required to avoid contact between adjacent blocker doors 120. Each proximate edge 130 is spaced apart from an inner surface of the translating sleeve 116 at a distance (D2) to provide minimum clearance to the aft cascade support structure, while each distal edge 132 is spaced apart from the IFS 112 at a distance (D3). Accordingly, the spacings between the proximate edges 130 and the translating sleeve 116 define leakage paths 124b (see FIG. 3B), while the spacings between the distal edges 132 and the IFS 112 define air leakage paths 124c.

The uppermost blocker doors 120a are spaced apart from an upper bifurcation 137 by a distance (D4) to define upper bifurcation leakage paths 124d. Similarly, the lowermost blocker 120b doors are spaced apart from a lower bifurcation 139 by a distance (D5) to define lower bifurcation air paths 124e. The annular ring of blocker doors 120 therefore essentially forms a wall that directs the majority of the airflow in the upstream portion 108 through the cascades assembly 122 (not shown in FIG. 2). However, a portion of the airflow is allowed to flow through the air leakage paths 124a-124e. The portion of the airflow leaked via the air leakage paths 124a-124e is increased compared to the blocker door assemblies included in conventional thrust reversers as discussed in greater detail below.

According to at least one embodiment, the spacings (e.g., D1-D5) defined by the blocker doors 120 are sized larger and formed at locations not found in conventional thrust reversers. For instance, conventional blocker doors as designed so as to minimize the air leakage past the thrust reverser, and instead maximize the airflow exhausted through the cascade array. In this manner, a minimal amount of airflow is allowed to pass by the blocker door assembly so as to minimize the amount of airflow that enters the downstream portion of the fan duct when the conventional blocker doors are fully deployed. For instance, conventional thrust reversers typically allow approximately 7% of the air flow to leak past conventionally shaped blocker doors.

Unlike conventional thrust reversers, however, at least one embodiment includes an arrangement of blocker doors 120 that defines spaces (e.g., D1-D3) between the tapered side edges 128, proximate edges 130 and distal edges 132, respectively. In this manner, a greater amount of airflow is allowed to leak past the blocker doors 120 and into the downstream portion 110 of the fan duct 112 when the blocker doors 120 are fully deployed, as compared to conventional thrust reversers. According to a non-limiting embodiment, the distances D1, D2, D4, and D5 defining the leakage paths 124a, 124b, 124d and 124e, respectively, are minimized while the distance D3 defining the distal edge leakage path 124c is maximized. In this manner, the lowest potential of the air flow in the fan duct 112 during thrust reverser deployed operation exists nearest to the IFS 106 surface. To maximize the reverse thrust for a given exhaust area provided by the thrust reverser 114, it is preferable to inhibit air flow from proceeding past the blocker doors 120 primarily through leakage paths 124d and 124e, while inhibiting air flow through leakage paths 124a and 124b as a secondary measure.

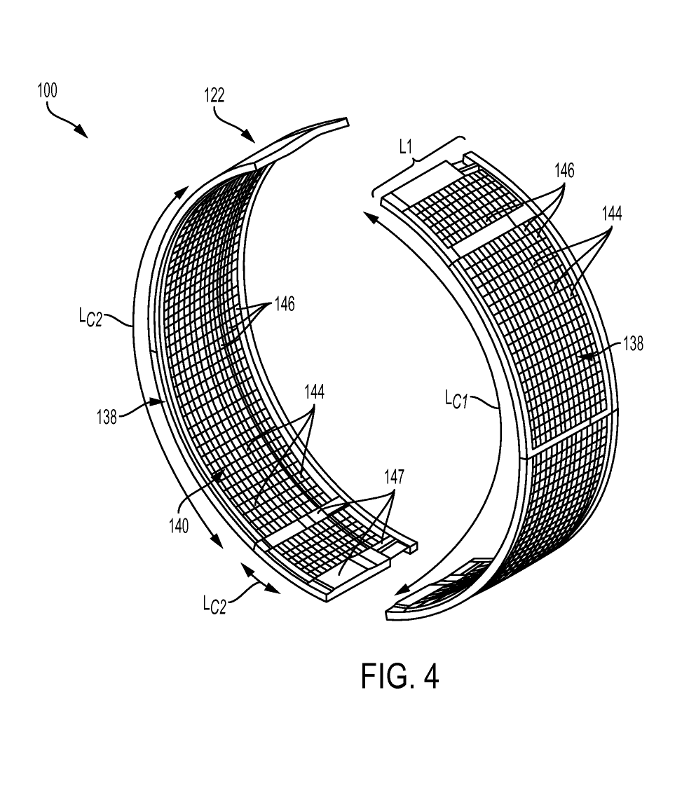

Turning now to FIG. 4, a cascade assembly 122 included in the propulsion system 100 is illustrated according to a non-limiting embodiment. The cascade assembly 122 extends circumferentially around the annular nacelle 104 to provide a means for exhausting air flow from the air duct (not shown in FIG. 4). The cascade assembly 122 includes an outer cascade array surface 138 and an inner cascade array surface 140. Each of the outer cascade array surface 138 and the inner cascade array surface 140 includes a plurality of turning vanes 144 having a grid-like arrangement to define a plurality of flow passages 146. The flow passages 146 of the outer cascade array surface 138 and the inner cascade array surface 140 are aligned with each other to form paths that allow the airflow to exit the fan duct when the blocker doors (not shown in FIG. 4) are fully deployed during a reverse thrust event. The cascade assembly 122 may further include one or more solid non-vented areas 147. These non-vented areas 147 typically support actuators (not shown) or other mechanical components. In other designs, the non-vented areas 147 may also exist to prevent the exiting air flow from impinging on certain surfaces of the aircraft. Accordingly, the portion of the inner cascade array surface 140 including the flow passages 146 defines an air flow area that is different from the overall structural area of the cascade assembly 122.

For instance, a first length (L₁) parallel with the longitudinal axis 102 and a first circumferential length (L_{C1}) of the cascade assembly 122 define a first overall circumferential area (A_{C1}). The first length (L₁) and a second circumferential length (L_{C2}) defined by the turning vanes 144 forming the inner cascade array surface 140 define a second (e.g. inner) circumferential area (A_{C2}). The second circumferential length (L_{C2}) defined by the turning vanes 144 can be defined as the first circumferential length (L_{C1}), less the areas occupied by the solid non-vented areas 147 (e.g., the actuators).

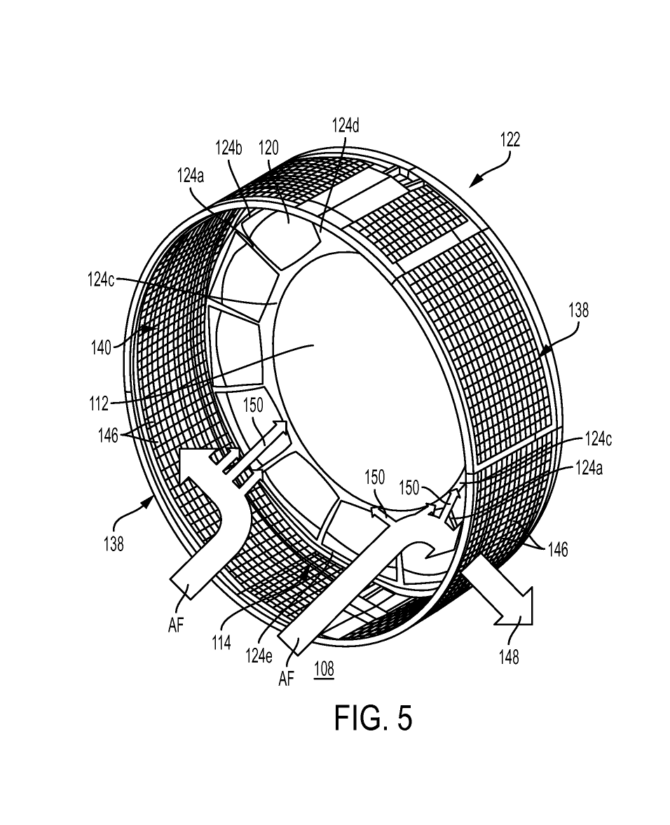

Turning now to FIG. 5, leakage area (A_{L}) according to a non-limiting embodiment. As described above, the blocker doors 120 define a plurality of air leakage paths 124a-124e. When taken in sum, the air leakage paths 124a-124e define a total leakage area (A_{L}). In other words, the difference between the total fan duct area and the area of the fan duct blocked by the blocker doors 120 defines the leakage area (A_{L}).

The input air flow stream (AF) flowing into the upstream portion 108 of the fan duct 112 is divided into one or more first airflow streams 148 and one or more second airflow streams 150. The first airflow streams 148 are forced to exit the fan duct 112 via the cascade assembly 122, while the second airflow streams 150 flow through the leakage paths 124a-124e and exit at the downstream portion of the fan duct (not shown in FIG. 5). The ratio of the airflow directed through the cascade assembly 122 versus the amount of airflow passing through the leakage paths 124a-124e and into the downstream portion of the fan duct is referred to as the mass air flow ratio (R_{MAF}). According to a non-limiting embodiment, approximately 80% of the total input airflow (AF) flowing into the inlet 108 is exhausted via the cascade assembly 122, while approximately 20% of the input airflow (AF) passes through the leakage paths 124a-124e and into the downstream portion where it is exhausted via the fan nozzle exit 110. In this manner, a mass air flow ratio (R_{MAF}) of 80_{cascade}:20_{downstream} is achieved. Although a R_{MAF} of 80_{cascade}:20_{downstream} is described above, it should be appreciated that the R_{MAF} is not limited thereto. For example, the percentage of the cascade flow may range from approximately 65% to 85% (with 80% being preferred), while the percentage of the downstream flow may range from approximately 15% to 35%.

The blocker doors 120 are also designed so as to define the total leakage area as a percentage of the inner circumferential area (A_{C2}) of the inner cascade array surface 140. That is, the inner circumferential area (A_{C2}) of the inner cascade array surface 140 is expressed as a cascade ratio (R_{C}) with respect to the total leakage area (A_{L}) defined by the plurality of blocker doors 120, i.e., R_{C}=A_{C2}:A_{L}. In this manner, the leakage area (A_{L}) can be structured as a function of the circumferential area (A_{C2}) of the inner cascade array surface 140 so as to achieve the desired mass air flow ratio described above (e.g., R_{MAF}=80ᵤₚₛₜᵣₑₐₘ:20_{downstream}). According to a non-limiting embodiment, the Rc ranges from approximately 0.15 (e.g., 15%) to approximately 0.35 (35%). For example, if the plurality of blocker doors 120 define an A_{L} of approximately 900 in², then the A2 of the inner cascade array 138 is approximately 6000 in². Conventional engine systems have a R_{C} ranging from about 0.06 (6%) to about 0.1 (10%). Therefore, at least one embodiment provides a R_{C} that is more than twice the conventional R_{C}.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of controlling a thrust reverser installed in a fan duct of an aircraft nacelle, the method comprising:
deploying a plurality of blocker doors interposed between an upstream portion of the fan duct and a downstream portion of the fan duct, the blocker doors defining a plurality of air leakage passages between the upstream portion and the downstream portion;
directing a first portion of an airflow stream flowing in the upstream portion through a cascade assembly disposed in the upstream portion of the fan duct; and
directing a second portion of the airflow stream through the air leakage passages defined by the blocker doors and into the downstream portion, wherein approximately 80 percent of the airflow stream is passed through the cascade assembly while approximately 20 percent of the airflow stream is passed through the air leakage passages.

2. The method of claim 1, wherein the plurality of air leakage paths include at least one distal edge leakage path defined by a first distance between a distal edge of each blocker door and an inner fixed structure (IFS), and wherein the plurality of air leakage paths include at least one side edge leakage path defined by a second distance between side edges of adjacent blocker doors.

3. The method of claim 2, wherein the plurality of leakage paths include at least one upper bifurcation path between a side edge of at least one uppermost blocker door and an upper bifurcation of the nacelle.

4. The method of claim 3, wherein the plurality of leakage paths include at least one lower bifurcation path between a side edge of at least one lowermost blocker door and a lower bifurcation of the nacelle.

5. The method of claim 4, wherein the plurality of leakage paths include at least one proximate edge path located between a proximate edge of at least one blocker door and a translating sleeve of the nacelle.

6. The method of claim 5, wherein a first amount of airflow of the second portion passes through the at least one side edge leakage path, the at least one upper bifurcation path, the at least one lower bifurcation path and the at least one proximate edge path, and a second amount of airflow of the second portion passes through the at least one distal edge leakage path.

7. The method of claim 6, wherein the second amount of airflow is greater than the first amount of airflow.

8. A thrust reverser included in an aircraft nacelle, comprising:
An annular nacelle having an inner hollowed area defining a fan duct, the fan duct extending longitudinally along an axis between an upstream inlet and a downstream outlet;
a blocker door assembly disposed in the fan duct and between the upstream inlet and the downstream outlet, the blocker door assembly configured to selectively deploy a plurality of blocker doors that extend radially from the nacelle into the fan duct so as to form a plurality of air leakage paths that define a total leakage area (A_{L}); and
a cascade assembly circumferentially disposed upstream from the blocker door assembly, the cascade assembly including a plurality of vents that define an inner circumferential area (A_{C2}) of the cascade assembly as a ratio (R_{C}) with respect to the A_{L}.

9. The thrust reverser of claim 8, wherein R_{C} ranges from approximately 15% to approximately 35%.

10. The reverse thruster of claim 9, wherein each blocker door includes a proximate edge pivotably coupled to an inner surface of the nacelle and a distal edge located opposite the proximate edge.

11. The thrust reverser of claim 10, wherein the nacelle further includes an inner fixed structure extending through the fan duct along the axis, and wherein a first distance between the distal edge of each blocker door and the inner fixed defines at least one distal edge leakage path.

12. The thrust reverser of claim 11, wherein a second distance separating a first side edge of a first blocker door from a second side edge of an adjacent blocker door defines at least one side edge leakage path.

13. The thrust reverser of claim 12, wherein the at least one distal edge leakage path is greater than the at least one side edge leakage path.

14. The thrust reverser of claim 12, wherein a third distance between a side edge of at least one uppermost blocker door and an upper bifurcation of the nacelle defines at least one upper bifurcation path.

15. The thrust reverser of claim 14, wherein a fourth distance between a side edge of at least one lowermost blocker door and a lower bifurcation of the nacelle defines at least one lower bifurcation path.

16. The thrust reverser of claim 15, wherein a fifth distance between a proximate edge of at least one blocker door and a translating sleeve of the nacelle defines at least one proximate edge leakage path.

17. The thrust reverser of claim 16, wherein each of the second distance, the third distance, the fourth distance, and the fifth distance are less than the first distance defining the distal edge leakage path.
